(19) United States
(12) Patent Application Publication
(10) Pub. No.: US 2010/0154097 A1
(43) Pub. Date: Jun. 24, 2010

(54) Battery powered accessory glove

(75) Inventor: Steven Karl Roscher, Seattle, WA (US)

Correspondence Address: Steven K. Roscher, 1106 16th Ave #6, Seattle, WA, 98122, US

(73) Assignee: Steven Karl Roscher, Seattle, WA (US)

(21) Appl. No.: 12/456,519

(22) Filed: Jun. 8, 2009

Related U.S. Application Data
(60) Provisional application No. 61/061,190, filed on Jun. 13, 2008.

(51) Int. Cl. A41D 19/00; H01R 24/00

(52) U.S. Cl. 2/160; 439/660

(57) ABSTRACT

A battery powered accessory glove includes a power pack with a plurality of plug-in outlet ports. The power pack includes a power switch, which the user can activate to send power to the outlets. Velcro fastener strips are located near the fingertips and are used to mount a device to the strips. The device is plugged into the corresponding outlet. The glove can be used to power gadgets that are directed to the wrist and arm. The Velcro fastener allows the user to make adjustments and allows the user to change the location of the device.

### CROSS-REFERENCE TO RELATED APPLICATIONS

This application claims the benefit of provisional patent application docket number 3885718 filed 2008 Jun. 13 by the present inventor.

### FEDERALLY SPONSORED RESEARCH

Not Applicable

### SEQUENCE LISTING OR PROGRAM

Not Applicable

### BACKGROUND

1. Field of the Invention

This invention relates to the field of entertainment, sport gloves and integrated light.

2. Description of Related Art

Performers, musicians, entertainers and dancers use a variety of props and devices to enhance their performances. Although there are many props and devices to choose from, many devices are handheld. Holding several devices or props together while performing is often difficult. Various gloved devices have been developed to power a plurality of illumination devices:

U.S. Pat. No. 6,892,297 B2 Glove with integrated light is used as an aid to illuminate a workspace environment, utilizing a single illumination device. Using a single illumination device would provide minimal entertainment value as opposed to using several devices.

U.S. Pat. No. 6,592,235 Light emitting glove comprises several illumination devices. The devices are electrically connected in serial form. This is not the best way to connect wires when using multiple devices. If a single device fails, the apparatus as a whole, would cease to function.

U.S. Pat. No. 6,711,746 Glove apparatus utilizes many illumination devices in a fixed alignment. The devices are aligned along many of the flex joint areas around the apparatus. The configuration creates constant stress to the wiring. Maintaining the device with a high volume of illumination devices would require frequent repairs.

U.S. Pat. No. 7,163,308 Hand worn illuminated framework provides an illuminated, temporary framework array. The invention is used for hand signal enhancement. The device uses a Velcro strap attached at the first finger joint to anchor parts of the lighting assembly from rotating. The framework can also be worn on the human hand. Wearing a Velcro band across the hand is not a comfortable or an economical method, since the wearer would have to remove the sticky band after each use and replace the band when it becomes dirty. Leaving out the band would mean that the user would need to keep the fingers straight. Bending the fingers would cause the framework to shift or misalign.

U.S. Pat. No. 4,820,229 Amusement device, U.S. Pat. No. 5,177,467 Alarming and entertaining glove and U.S. Pat. No. 5,580,154 Glow-in-the-dark glove apparatus, are used for entertainment purposes and power several illumination and audio devices in various configurations. A disadvantage would be that the audio devices could interfere with a musical performance. Another disadvantage is that the apparatuses are large and bulky; the user could have difficulties holding other handheld items such as a prop or a musical instrument. Yet another disadvantage is that several of the apparatuses utilize a trigger switch located on the finger portion. This could be an undesirable feature for a performance environment.

The first disadvantage is that all of the previously mentioned inventions use configurations of illumination or audio devices that are pre-determined by the inventor, not the user. Another disadvantage is that the devices are hard wired, if any of the illumination or audio devices malfunctions or fails on the glove apparatus or framework device, the apparatus as a whole must be repaired. Adding new devices or upgrades would require the apparatus being sent to the manufacturer. A third disadvantage is the user may not be able to adjust the angle or direction of the output of the illumination device away from the preset position or finger placement.

### SUMMARY

The first embodiment of an apparatus to power a plurality of illumination, motorized and electronic devices comprises a glove to be worn on the user's hand. A housing containing the power source is attached to the exterior portion of the glove. The power source unit comprises a battery case and a power switch located in the rounded housing. The power unit comprises plug-in outlets that face towards the fingers. Velcro temporary fastener strips are attached to the exterior of the glove near the fingertips. The strips are used to attach an array of accessories. Hand accessories use the temporary fastener material to mount onto the strips of the temporary fastener material located near the fingertips and are plugged into the power unit.

The second embodiment of an apparatus to power a plurality of illumination, motorized and electronic devices, comprising additional plug-in outlets. A plurality that face towards the fingers and two that face towards the arm. This would be the only difference from the first embodiment. Arm accessories may be clipped onto a watchband, wristband, armband, and clothing.

### BRIEF DESCRIPTION OF THE DRAWINGS

FIG. 1: is an illustration of present invention with one accessory.

FIG. 2: is the view of the unassembled battery section of the glove

FIG. 3: shows present invention with hand, wrist and arm accessories.

### NUMBER DESCRIPTION LIST

8: is the glove body
10: is the battery powered accessory glove
12: is the top cover portion of the device
14: is the power switch
16: is the battery case
18: are the outlet ports
20: is the view of the unassembled battery section of the glove
22: is the device with a Velcro fastener band attached to the device
24: is the Velcro fastener attached to the glove
26: are the outlet ports on the bottom of the battery case
28: is the view of the gadget attached to the arm, which receives power from the glove battery
30: is the view of the glove on the user
32: is the view of the gadget attached to the arm, which receives power from the glove battery
32: is the cover of the device
36: is the power device

### DETAILED DESCRIPTION

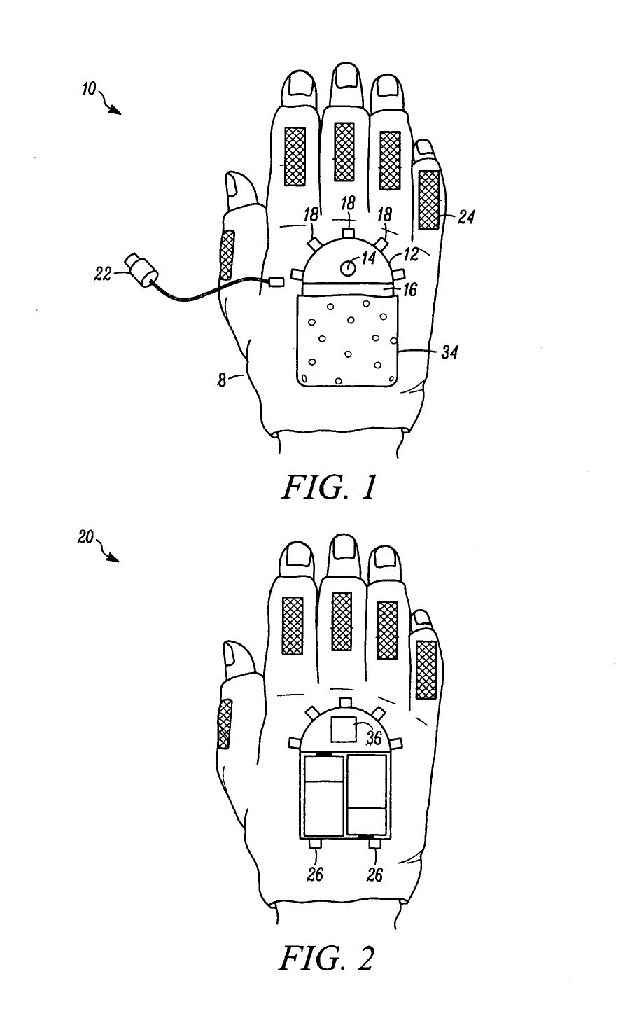

As shown in FIG. 1 the embodiment comprises a glove apparatus 10 illustrated in accordance with present invention. Glove apparatus is shown comprising a glove body 8 with five 1.5-inch temporary fastener strips 24, integrated with a power distribution housing 12,16. The temporary fastener strips 24 are attached to the glove body 8 near the finger openings. The power distribution housing comprises a power distribution portion 12 and a battery portion 16 is mounted to the back portion of the glove, centered above the wrist opening. Small holes on the undercarriage of the battery portion 16 allow the housing to be fastened to the glove body. The housing 12,16 is fastened to the glove body with cable ties (not shown). The power distribution housing contains a power switch 14 located in a central location within the housing. Plug-in outlet ports 18 are attached to the rounded outer wall of the power distribution housing 12. The plug-in outlets 18 connect electrically to the power switch 14. Electrical connections are contained within the housing 12 (not shown). A battery case cover 34 is attached to the battery portion 16 of the housing.

A second embodiment as shown in FIG. 2, the glove apparatus 20 shows the battery portion with two plug-in outlet ports 26 attached to the power distribution housing. The plug-in outlets 26 are electrically connected to the power switch.

An additional feature shown in FIG. 2 that may be present in both embodiments is the power distribution housing comprising a vibration-tilt switch 36 or an audio synchronization circuit 36 or a flashing circuit 36. The previous examples connect electrically from the batteries to the power switch and are housed internally.

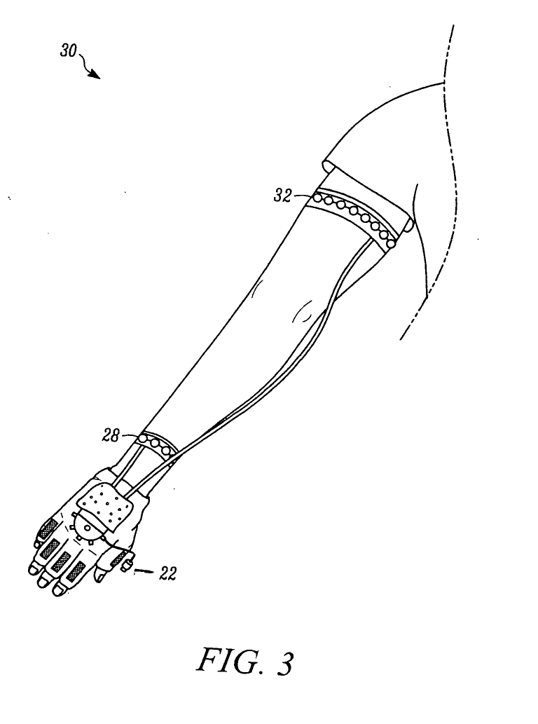

The user would attach and connect the device 22 or gadget(s) 28,32 as shown in FIG. 3. The glove apparatus 30 is shown being worn by the user with a device and gadgets 22, 28 and 32 plugged in. The user would be able to connect and attach additional devices as desired.

The power switch activates the configuration of devices and gadgets. The user is able to perform many normal tasks uninhibited by the apparatus. A laser module diode, light emitting diode, motor, driver-flasher device, transformer or incandescent illumination source are a few examples that can be applied to the apparatus.

Accordingly, the primary object of the invention is to provide a glove structure with means to power an array of devices and gadgets, allowing the user to choose a multitude of personal configurations.

Another object of the present invention is to provide a means for easy replacement when a device or gadget fails. Yet another objective is to allow the user a means for adding new devices or gadgets. Thus the reader will see that at least one of the embodiments of the accessory glove provides the user with the ability to create a glove apparatus accordingly with the user's needs. The plug-in feature benefits the user in several ways. If a device were to malfunction or cause the wiring to short, the device can be removed. This allows for continued use of remaining devices. A spare can be used to restore complete function if all plug-in outlets are utilized and desired. Repairing the device instead of the entire apparatus would save money in shipping costs. When the batteries become weak, the user can reduce the number of devices in use, to extend battery life. The temporary fastener feature allows the user to make quick adjustments to the angle, direction and placement of the device.

While the above description contains many specificities, these should not be construed as limitations on the scope, but rather as an exemplification of one [or several] preferred embodiment thereof. Many other variations are possible. Accordingly, the scope should be determined not by the embodiments illustrated, but by the appended claims and their legal equivalents.

What is claimed is:

1. A battery powered apparatus to power a plurality of accessory devices comprising:
(a) A glove body to be worn on the users hand, said glove comprising an exterior surface and an interior surface.
(b) A power distribution means comprising:
A housing mounted to the exterior portion of the glove in a location that does not inhibit the operator. A power source and power switch is housed within the said housing. A plurality of plug-in outlet ports attached to the exterior of the said housing. A battery cover attached to the said housing.
(c) A plurality of temporary fastener material strips mounted to the finger portion on the exterior portion of said glove.

2. A singular or plurality of devices comprising a strip of temporary fastener material and a plug-in connector.

3. A singular or plurality of gadgets comprising a plug-in connector.

4. A glove apparatus as described in claim 1, wherein: said power distribution housing comprising a tilt-motion power switch member integrally assembled and being a structural part of said glove member.

5. A glove apparatus as described in claim 1, wherein: said power distribution housing comprising a flasher circuit system integrally assembled and being a structural part of said glove member.

6. A glove apparatus as described in claim 1, wherein: said power distribution housing comprising an audio synchronization circuit system integrally assembled and being a structural part of said glove member.

7. The apparatus of claim 1, wherein: said housing is made of molded plastic.

8. A glove apparatus as described in claim 1, wherein: said housing comprising a plurality of plug-in outlet ports integrally assembled and being a structural part of said glove member
